(19) United States
(12) Patent Application Publication
(10) Pub. No.: US 2016/0089968 A1
(43) Pub. Date: Mar. 31, 2016

(54) AMT HYBRID TRANSMISSION

(71) Applicant: Hyundai Motor Company, Seoul (KR)

(72) Inventors: Keun Seok LEE, Hwaseong-si (KR); Kum Lim CHOI, Seoul (KR)

(73) Assignee: Hyundai Motor Company, Seoul (KR)

(21) Appl. No.: 14/561,140

(22) Filed: Dec. 4, 2014

(30) Foreign Application Priority Data
Sep. 29, 2014 (KR) 10-2014-0129965

(51) Int. Cl. B60K 6/36; B60K 6/54; B60K 6/442

(52) U.S. Cl. CPC B60K 6/36; B60K 6/442; B60K 6/54; Y10S 903/909; Y10S 903/917

(57) ABSTRACT

An Automated Manual Transmission (AMT) type of hybrid transmission may include a first input shaft connected to an engine through a clutch, a second input shaft disposed coaxially with the first input shaft and connected to a motor, a plurality of driving gears on the first input shaft, a first output shaft disposed in parallel with the first input shaft and having a plurality of driven gears that are engaged with the driving gears to shift, a second output shaft disposed in parallel with the first input shaft and having a plurality of driven gears that are engaged with the driving gears to shift, a first connecting mechanism connecting/disconnecting the second input shaft to/from the first input shaft, and a second connecting mechanism connecting/disconnecting the second input shaft to/from the second output shaft.

### CROSS REFERENCE TO RELATED APPLICATION

The present application claims priority to Korean Patent Application Number 10-2014-0129965 filed Sep. 29, 2014, the entire contents of which is incorporated herein for all purposes by this reference.

### BACKGROUND OF THE INVENTION

1. Field of the Invention

The present invention, in general, relates to an AMT (Automated Manual Transmission) type of hybrid transmission, and, more particularly, to a structure of a transmission that can improve fuel efficiency of a vehicle and improve shifting ability.

2. Description of Related Art

An AMT (Automated Manual Transmission) has the advantage of being able to provide convenience for a driver by automatically shifting in accordance with the driving conditions of a vehicle, similar to the automatic transmission of the related art, and also has the high power transmission efficiency of the manual transmission of the related art.

However, the AMT based on the mechanism of the manual transmission of the related art is necessarily accompanied by power disconnection while disengaging the current gear and engaging the next gear, so a shock is generated in shifting.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an Automated Manual Transmission (AMT) type of hybrid transmission that can improve shifting ability by preventing complete disconnection of power transmitted to a driving wheel, because it can assist torque in shifting, and can improve fuel efficiency of a vehicle by implementing regenerative braking and an electric vehicle mode.

According to various aspects of the present invention, an AMT type of hybrid transmission may include a first input shaft connected to an engine through a clutch, a second input shaft disposed coaxially with the first input shaft and connected to a motor, a plurality of driving gears on the first input shaft, a first output shaft disposed in parallel with the first input shaft and having a plurality of driven gears that are engaged with the driving gears to shift, a second output shaft disposed in parallel with the first input shaft and having a plurality of driven gears that are engaged with the driving gears to shift, a first connecting mechanism connecting/disconnecting the second input shaft to/from the first input shaft, and a second connecting mechanism connecting/disconnecting the second input shaft to/from the second output shaft.

The motor may surround the second input shaft, with its rotary shaft disposed coaxially with the second input shaft.

The first connecting mechanism may include a connecting member connecting the second input shaft and the motor to each other and a first synchronizer connecting/disconnecting the first input shaft.

The connecting member may have a recession at a center thereof and an end of the first input shaft may be inserted in the recession of the connecting member, coaxially with the second input shaft.

The second connecting mechanism may include a first connecting gear disposed on the second input shaft and freely rotated thereon to transmit power to the second output shaft and a second synchronizer disposed on the second input shaft to restrict/allow rotation.

The connecting member may be disposed between the first synchronizer and the second synchronizer and the motor may surround the connecting member.

According to the present invention, it is possible to improve shifting ability by preventing complete disconnection of power transmitted to a driving wheel through torque assist in shifting and improve fuel efficiency of a vehicle by implementing regenerative braking and an electric vehicle mode.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing the structure of an exemplary Automated Manual Transmission(AMT) type of hybrid transmission according to the present invention.

FIG. 2 is a diagram illustrating an EV1 mode implemented by the transmission of FIG. 1.

FIG. 3 is a diagram illustrating that a second gear is engaged in the transmission of FIG. 1 in an EV2 mode.

FIG. 4 is a diagram illustrating that a third gear is engaged in the transmission of FIG. 1 in the EV2 mode.

FIG. 5 is a diagram illustrating that the first gear is engaged in the transmission of FIG. 1 in an HEV1 mode.

FIG. 6 is a diagram illustrating that the second gear is engaged in the transmission of FIG. 1 in the HEV1 mode.

FIG. 7 is a diagram illustrating that the third gear is engaged in the transmission of FIG. 1 in the HEV1 mode.

FIG. 8 is a diagram illustrating that a fourth gear is engaged in the transmission of FIG. 1 in an HEV2 mode.

FIG. 9 is a diagram illustrating that a fifth gear is engaged in the transmission of FIG. 1 in the HEV2 mode.

FIG. 10 is a diagram illustrating that a sixth gear is engaged in the transmission of FIG. 1 in the HEV2 mode.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

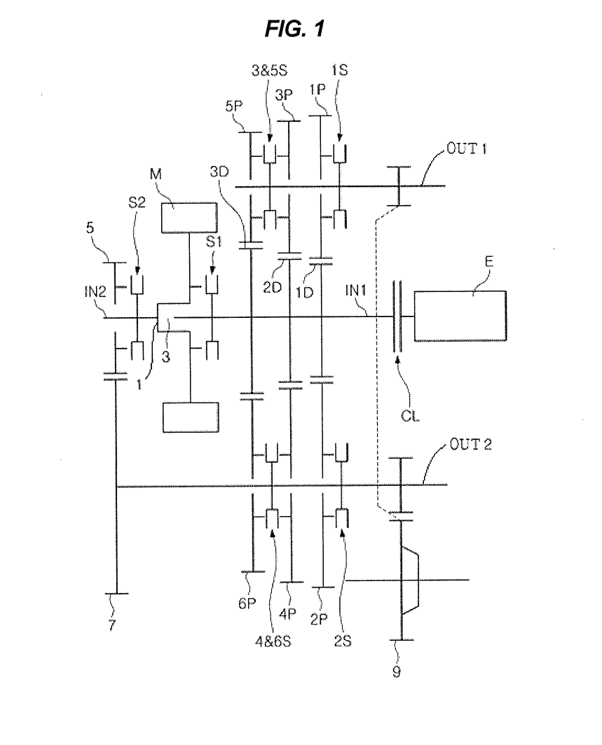

Referring to FIG. 1, various embodiments of the present invention include a first input shaft IN1 that is connected to an engine E through a clutch CL, a second input shaft IN2 that is disposed coaxially with the first input shaft N1 and connected to a motor M, a plurality of driving gears on the first input shaft IN1, a first output shaft OUT1 that is disposed in parallel with the first input shaft IN1 and has a plurality of driven gears that are engaged with the driving gears to shift, a second output shaft OUT2 that is disposed in parallel with the first input shaft IN1 and has a plurality of driven gears that are engaged with the driving gears to shift, a first connecting mechanism that connects/disconnects the second input shaft IN2 to/from the first input shaft IN1, and a second connecting mechanism that connects/disconnects the second input shaft IN2 to/from the second output shaft OUT 2.

That is, according to the present invention, the first input shaft Ni receives power from an engine E through the clutch CL, the second input shaft IN2 is connected directly to the motor M, and power from the motor M can be selectively transmitted to the first input shaft IN1 or the second output shaft OUT2, so it is possible to implement an EV mode that is an electric vehicle mode for driving a vehicle only with the power from the motor M and an HEV mode that is a hybrid mode for driving a vehicle with the power from both of the motor M and the engine E. Therefore, it is possible to provide an independent power path through which the power from the motor M can be transmitted to the driving wheels, independent from a power path for transmitting the power from the engine E to the driving wheels, in shifting, so that it is possible to improve shifting ability without disconnection of power in shifting.

The motor M surrounds the second input shaft IN2, with its rotary shaft disposed coaxially with the second input shaft IN2.

The first connecting mechanism is composed of a connecting member 1 that connects the second input shaft IN2 and the motor M to each other and a first synchronizer Si that connects/disconnects the first input shaft IN1.

The connecting member 1 has a recession 3 at the center and an end of the first input shaft IN1 is inserted in the recession 3 of the connecting member 1, coaxially with the second input shaft IN2.

The second connecting mechanism is composed of a first connecting gear 5 disposed on the second input shaft IN2 and freely rotated thereon to transmit power to the second output shaft OUT2 and a second synchronizer S2 disposed on the second input shaft IN2 to restrict/allow rotation.

The connecting member 1 is disposed between the first synchronizer Si and the second synchronizer S2 and the motor M surrounds the connecting member 1.

The first synchronizer S1 and the second synchronizer S2 may be replaced by a dog clutch CL, but may not be replaced because it is actually required to connect elements having relative speeds while a vehicle runs.

The driving gears on the first input shaft IN1 are engaged with both of the driven gear on the first output shaft OUT1 and the driven gear on the second output shaft OUT1 to achieve different gear ratios. In the present embodiment, odd-numbered shifting of first shifting, third shifting, and fifth shifting is achieved by engagement of the driving gears and the driven gears between the first input shaft IN1 and the first output shaft OUT1 and even-numbered shifting of second shifting, fourth shifting, and sixth shifting is achieved by engagement of the driving gears and the driven gears between the first input shaft IN1 and the second output shaft OUT2.

For reference in FIG. 1, a first driven gear 1P and a second driven gear 2P are both engaged with a first driving gear 1D, a third driven gear 3P and a fourth driven gear 4P are both engaged with a second driving gear 2D, and a fifth driven gear 5P and a sixth driven gear 6P are both engaged with a third driving gear 3D.

Further, the first output shaft OUT1 has a first shifting synchronizer 1S for first shifting and a third/fifth synchronizer 3&5S for third shifting and fifth shifting and the second output shaft OUT2 has a second shifting synchronizer 2S for second shifting and a fourth/sixth shifting synchronizer 4&6S for fourth shifting and sixth shifting.

Obviously, shifting by the first output shaft OUT1 and the second output shaft OUT2 may be implemented in other orders and in other ways.

A second connecting gear 7 that is engaged with the first connecting gear 5 of the second input shaft IN2 is integrally formed on the second output shaft OUT2 so that the second output shaft OUT2 can be driven by power transmitted from the first connecting gear 5.

The first output shaft OUT1 and the second output shaft OUT2 can separately output power to a ring gear 9 of a differential by being engaged with the ring gear 9.

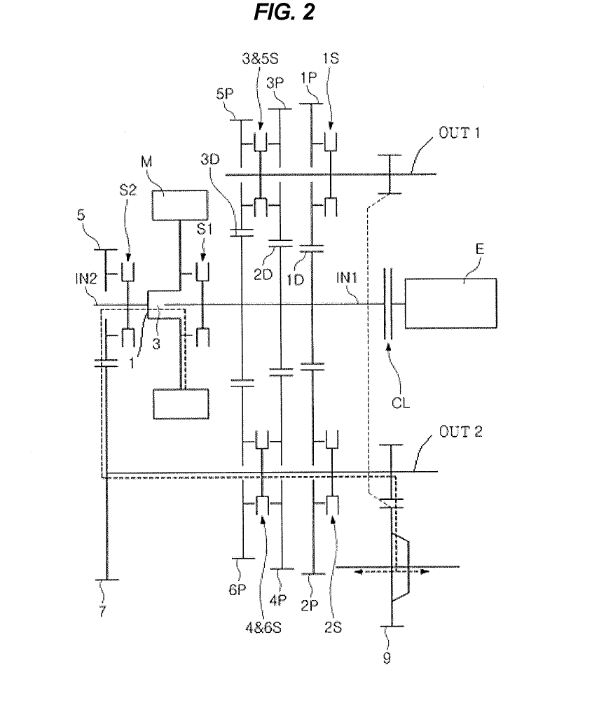

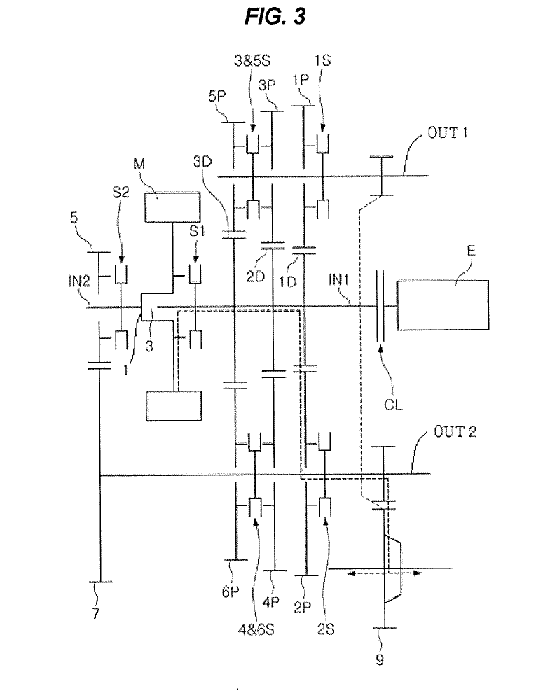

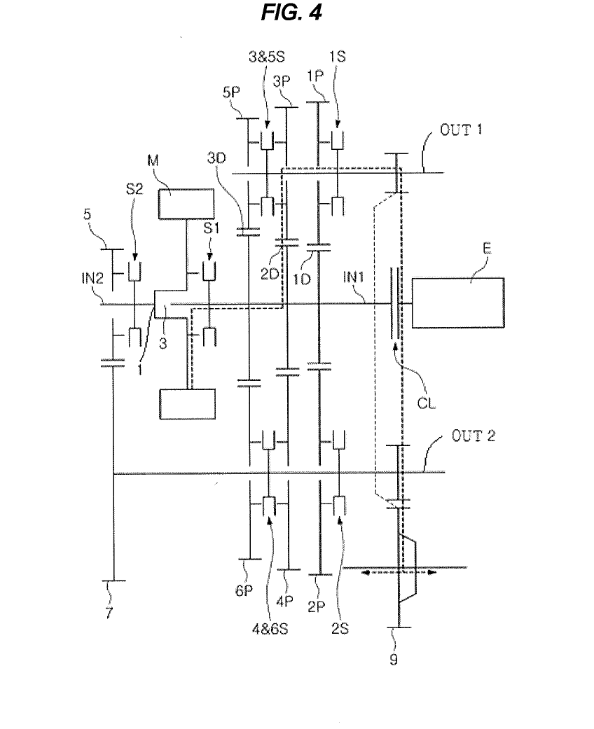

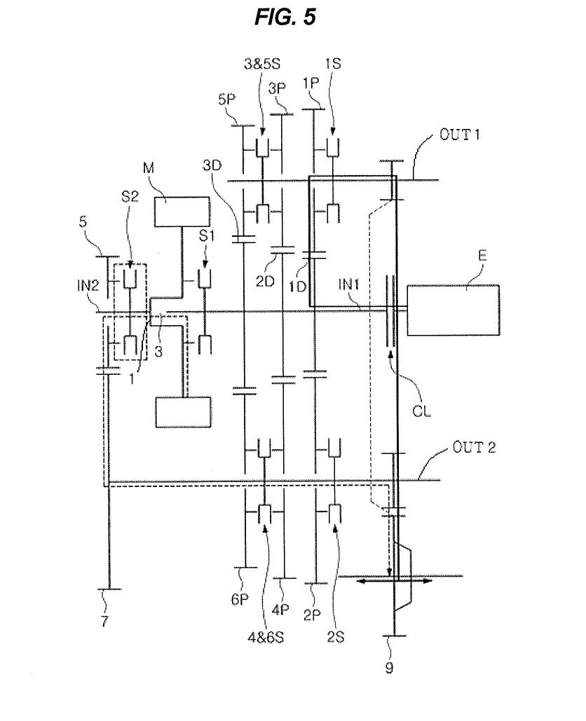

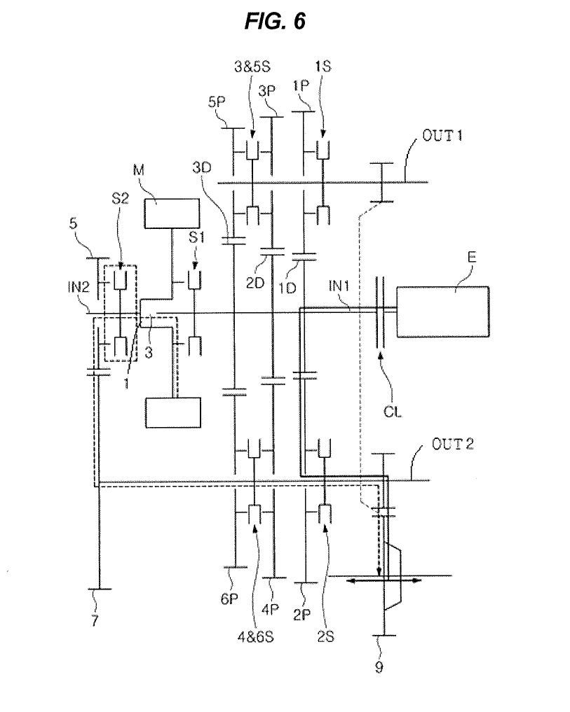

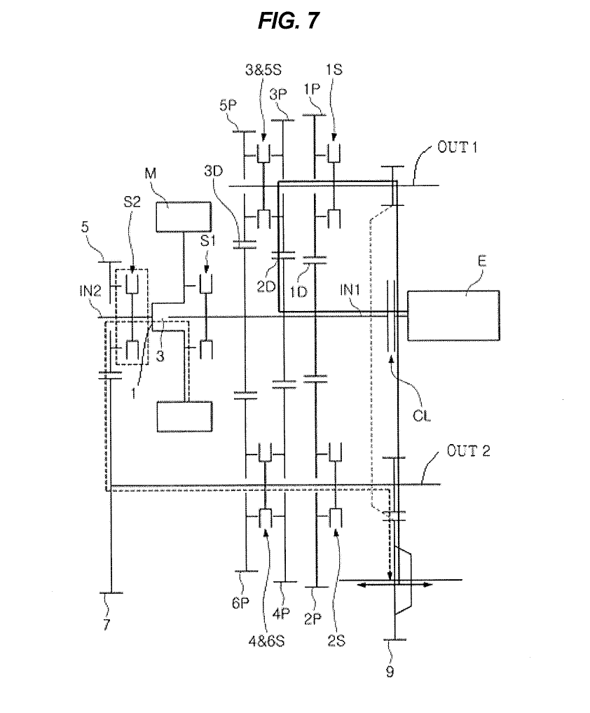

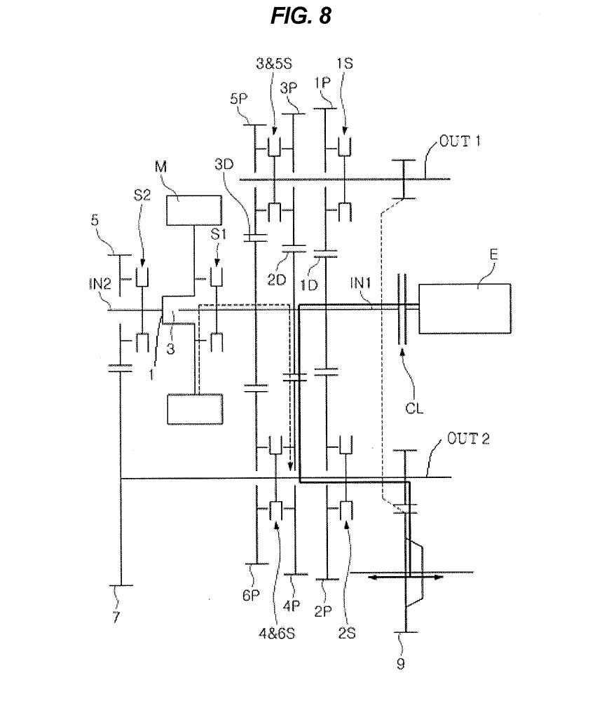

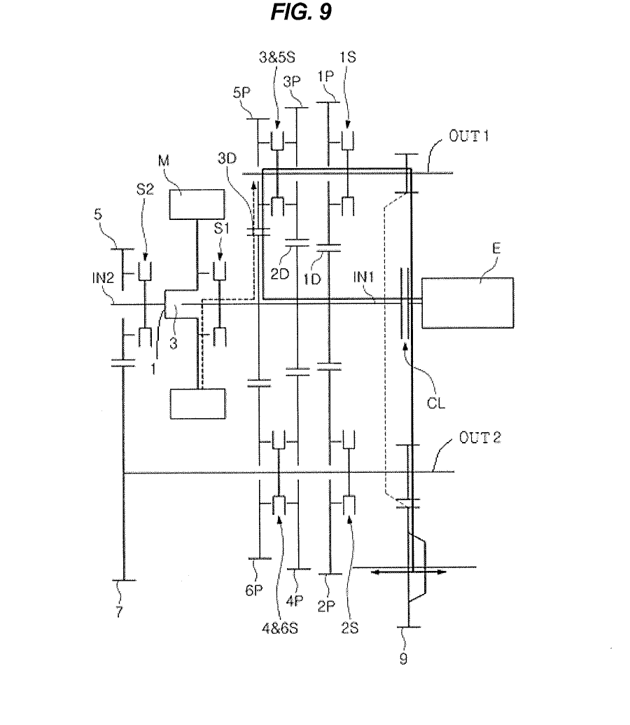

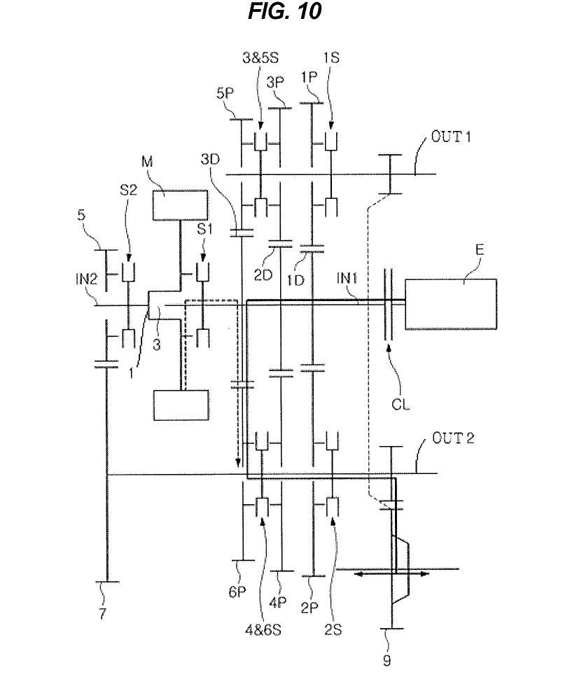

The operation of an embodiment of the present invention is described hereafter with reference to FIG. 2, FIG. 3, FIG. 4, FIG. 5, FIG. 6, FIG. 7, FIG. 8, FIG. 9 and FIG. 10.

FIG. 2 shows an EV1 mode, in which a motor M is driven, with the first connecting gear 5 connected to the second input shaft IN2 by the second synchronizer S2, and the power from the motor M is outputted to the second output shaft OUT2 through the first connecting gear 5 and the second connecting gear 7.

FIG. 3 shows an EV2 mode, in which the second synchronizer S2 is disengaged, but the first synchronizer Si is engaged, so the power from the motor M is transmitted to the first input shaft IN1, with the clutch CL disengaged.

The second shifting synchronizer 2S of the second output shaft OUT2 is coupled, so the power from the motor M is outputted after being changed for second shifting between the first input shaft IN1 and the second input shaft OUT.

FIG. 4 shows third shifting in the EV2 mode, in which, as in FIG. 3, the first synchronizer S1 connects the second input shaft IN2 connected to the motor M to the first input shaft, so the power from the motor M is transmitted to the first input shaft IN1, and the third/fifth shifting synchronizer 3&5S connects the third driven gear 3P to the first output shaft OUT1, so the power from the motor M is outputted to the ring gear 9 of the differential after being changed for third shifting between the second driving gear 2D and the third driven gear 3P.

As described above, when the synchronizers for shifting are selectively coupled, with the power from the motor M transmitted to the first input shaft IN1 through the first synchronizer S1, first, fourth, fifth, and sixth shifting can be achieved in the same way in the EV2 mode, and the EV1 mode shown in FIG. 2 can be achieved by coupling the second synchronizer S2 instead of the first synchronizer S1.

FIG. 5, FIG. 6, and FIG. 7 show first shifting to third shifting in an HEV1 mode, respectively, in which, basically, the EV1 mode in which the power from the motor M is transmitted to the second output shaft OUT1 with the second synchronizer S2 coupled has been implemented, the power from the engine is changed for shifting and outputted to the ring gear of the differential by coupling the first shifting synchronizer 1S, the second shifting synchronizer 2S, and the third/fifth shifting synchronizer 3&5S and engaging the clutch CL, so a hybrid state is achieved.

Obviously, it is possible to achieve first shifting to sixth shifting in the HEV1 mode by selectively coupling all the shifting synchronizers including the fourth/sixth shifting synchronizer 4&6S, other than the first shifting synchronizer 1S, the second shifting synchronizer 2S, and the third/fifth shifting synchronizer 3&5S.

Further, the shifting by the gears is achieved by disengaging the clutch CL, releasing the current shifting synchronizer and coupling a new shifting synchronizer, and then engaging the clutch CL again, with the power from the motor M continuously transmitted to the ring gear 9 of the differential through the second synchronizer S2 and the second output OUT2, in which torque is continuously transmitted to driving wheels, so a shock in shifting is prevented.

FIG. 8, FIG. 9 and FIG. 10 show fourth shifting to sixth shifting in an HEV2 mode, in which, basically, the fourth shifting to sixth shifting are achieved by selectively coupling the fourth/sixth shifting synchronizer 4&6S and the third/fifth synchronizer 3&5S and engaging the clutch CL so that the power from the engine can be provided to driving wheels together with the power from the motor M, with the first synchronizer Si coupled and the power from the motor M1 transmitted to the first input shaft IN1.

That is, the fourth shifting is achieved when the fourth/sixth shifting synchronizer 4&65 connects the fourth driven gear 4P to the second output shaft IN2, the sixth shifting is achieved when the fourth/sixth shifting synchronizer 4&6S connects the sixth driven gear 6P to the second output shaft OUT2, and the fifth shifting is achieved when the third/fifth synchronizer 3&5S connects the fifth driven gear 5P to the first output shaft OUT1.

Obviously, first shifting and third shifting in an HEV2 mode can be achieved, as described above, by connecting the first driven gear 1P to the first output shaft OUT1 by means of the first shifting synchronizer 1S, connecting the second driven gear 2P to the second output shaft OUT2 by means of the second shifting synchronizer 2S, and connecting the third driven gear 3P to the first output shaft OUT1 by means of the third/fifth synchronizer 3&5S.

On the other hand, for example, in order to change from the EV1 mode shown in FIG. 2 to the third shifting in the EV2 mode shown in FIG. 4, by engaging the clutch CL so that the power from the engine is changed and outputted through the first input shaft IN1 and the first output shaft OUT1, with the third driven gear 3P connected to the first output shaft OUT1 by the third/fifth shifting synchronizer 3&5S, from the state shown in FIG. 2, the state shown in FIG. 7 is achieved, and by then stopping the motor M and disengaging the second synchronizer 2S, the state shown in FIG. 4 is achieved. Accordingly, it is possible to change the driving modes while power keeps being transmitted to driving wheels.

On the other hand, it is possible to achieve an engine mode in which power is outputted after shifting by any one of the shifting synchronizers, with both of the first synchronizer S1 and the second synchronizer S2 disengaged and only the power from the engine transmitted to the first input shaft N1 through the clutch CL.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An Automated Manual Transmission (AMT) type of hybrid transmission comprising:
a first input shaft connected to an engine through a clutch;
a second input shaft disposed coaxially with the first input shaft and connected to a motor;
a plurality of driving gears on the first input shaft;
a first output shaft disposed in parallel with the first input shaft and having a plurality of driven gears that are engaged with the driving gears to shift;
a second output shaft disposed in parallel with the first input shaft and having a plurality of driven gears that are engaged with the driving gears to shift;
a first connecting mechanism connecting/disconnecting the second input shaft to/from the first input shaft; and
a second connecting mechanism connecting/disconnecting the second input shaft to/from the second output shaft.

2. The hybrid transmission of claim 1, wherein the motor surrounds the second input shaft, with its rotary shaft disposed coaxially with the second input shaft.

3. The hybrid transmission of claim 2, wherein the first connecting mechanism includes a connecting member connecting the second input shaft and the motor to each other and a first synchronizer connecting/disconnecting the first input shaft.

4. The hybrid transmission of claim 3, wherein the connecting member has a recession at a center thereof and an end of the first input shaft is inserted in the recession of the connecting member, coaxially with the second input shaft.

5. The hybrid transmission of claim 3, wherein the second connecting mechanism includes a first connecting gear disposed on the second input shaft and freely rotated thereon to transmit power to the second output shaft and a second synchronizer disposed on the second input shaft to restrict/allow rotation.

6. The hybrid transmission of claim 5, wherein the connecting member is disposed between the first synchronizer and the second synchronizer and the motor surrounds the connecting member.
